(19) United States
(12) Patent Application Publication
(10) Pub. No.: US 2023/0092883 A1
(43) Pub. Date: Mar. 23, 2023

(54) CLOUD-BASED MEASURING POINT REGISTRATION SYSTEM

(71) Applicant: VEGA GRIESHABER KG, Wolfach (DE)

(72) Inventors: Ralf HOELL, Titisee-Neustadt (DE); Juan GARCIA, Biberach (DE)

(73) Assignee: VEGA GRIESHABER KG, Wolfach (DE)

(21) Appl. No.: 17/948,974

(22) Filed: Sep. 20, 2022

(30) Foreign Application Priority Data
Sep. 20, 2021 (DE) 10 2021 124 288.6

(51) Int. Cl. G05B 19/042

(52) U.S. Cl. CPC G05B 19/042; G05B 2219/25428

(57) ABSTRACT

A cloud-based measuring point registration system that registers a field device in a cloud-based field device control system. The cloud-based measuring point registration system includes a readout device on which an operating program is installed. The readout device logs into the cloud-based field device control system. Furthermore, the readout device verifies the identification feature of the field device and thereupon adds the field device to the cloud-based field device control system as a new field device and thus registers the field device.

### CROSS-REFERENCE TO RELATED APPLICATIONS

This application claims the benefit of the filing date of German Patent Application No. 10 2021 124 288.6 filed on 20 Sep. 2021, the entire content of which is incorporated herein by reference.

### FIELD

The disclosure relates to process measurement technology. In particular, the disclosure relates to a cloud-based measuring point registration system, a method for registering a field device in a cloud-based field device control system, multiple uses, a program element, and a computer-readable medium.

### BACKGROUND

In process and factory automation, field devices that transmit measurement data to other elements of the control system are used to monitor and control processes. Such field devices can be used, for example, to determine a fill level, limit level, pressure, temperature or flow rate or to monitor other process parameters. The configuration of such field devices can be demanding and time-consuming, depending on the complexity of the process.

### SUMMARY

It is an object of the disclosure to reduce the susceptibility to error in the configuration of the field device.

This object is solved by the subject-matter of the independent patent claims. Further embodiments result from the subclaims and the following description.

One aspect relates to a cloud-based measuring point registration system configured to register a field device in a cloud-based field device control system. The cloud-based measuring point registration system comprises a readout device configured to read out an identification feature of the field device.

The readout device can take the form of a smartphone, tablet, laptop or smartwatch, for example. The readout device is set up to log into the cloud-based field device control system. Furthermore, the readout device is configured to verify the identification feature of the field device and then to add the field device to the cloud-based field device control system as a new field device and thus to register it.

According to an embodiment, the readout device is set up to log into the cloud-based field device control system when an operating program is started. Furthermore, the readout device is set up to read out the identification feature of the field device in response to a corresponding request from the cloud-based field device control system.

The identification feature of the field device may, for example, be stored on the internal register of the field device; alternatively or additionally, the identification feature may be implemented as a badge on the device.

The identification feature can be secured by the coding. The identification feature may be implemented as a barcode or as a QR code (QR: “Quick Response” code) and/or in another representation. Furthermore, the identification feature may be implemented as a near-field communication module that transmits the encoded or recoded signal, for example, by means of an RFID (Radio-Frequency Identification). The identification feature can be read out via near-field communication, via a QR code and/or via an OCR scan.

The QR code can, for example, be stored on the register of the field device or displayed on the nameplate in accordance with a standard—e.g. DIN SPEC 91406:2019-12 “Automatic identification of physical objects and information on the physical object in IT systems, in particular IoT systems; text in German and English”. The QR code may link the device to a so-called “digital twin”, e.g. by providing the QR code with a link to documentation, parameter setting, history, firmware, test protocols, drawings, device status, etc. of the field device. Furthermore, the QR code can be used to obtain authorization for device access (“login”).

An advantage of the present disclosure arises from simple, fast, error-minimized, and cost-effective measuring point registration to a cloud-based system, by replacing the manual specification of data, such as IP addresses, ports, serial numbers, or the like, in the automated transmission. Another advantage of the present disclosure may result from a secure registration of the field device in the cloud-based system by creating the account with the cloud-based system and the operator program. Advantageously, the field device registration can also be performed by technically less qualified personnel.

According to an embodiment, the cloud-based measurement point registration system comprises a cloud-based field device control system arranged to control the field device. The cloud-based field device control system may be implemented as a visualization system for monitoring and controlling the processes.

Such cloud-based field device control systems store the data of field devices used in a globally distributed manner. The field device control system stores data from wired field devices, e.g. by using interfaces like 4 . . . 20 mA, 4 . . . 20 mA/HART, Profibus, Foundation Fieldbus, Ethernet. The field device control system further features data from wireless transmitting field devices, e.g. by using interfaces like Bluetooth, WiFi, LoRa, GSM/GPRS/UMTS/LTE [4G], 5G, NB-IoT, Sigfox.

Advantageously, such field device control systems summarize the data over a very wide range of field devices and can automatically suggest the settings for similar devices.

According to an embodiment, the cloud-based field instrument control system is a VEGA Inventory System. The VEGA Inventory System is a web-based software for data acquisition and visualization of level data, e.g. in storage tanks and silos. The local server version is particularly suitable for monitoring levels within a company.

According to a further embodiment, the cloud-based measuring point registration system comprises a field device arranged for registration in the cloud-based field device control system.

The field device may have a wireless interface that uses, for example, Bluetooth, WiFi, LoRa, GSM/GPRS/UMTS/LTE [4G], 5G, NB-IoT, or Sigfox wireless network to transmit the registration data to the cloud-based system.

Alternatively or additionally, the field device can have a wired interface such as two-wire loop 4 . . . 20 mA, 4 . . . 20 mA/HART, Profibus, Foundation Fieldbus, Ethernet.

For example, the registration data may receive a link to documentation, parameter setting, history, firmware, test records, drawings, device status, etc. of the field device.

According to an embodiment, the cloud-based measurement point registration system comprises a field device that is-set up for level, temperature,-pressure, density, level limit, and/or flow measurement.

According to an embodiment, the identification feature of the field device is read via near-field communication, via a QR code, and/or via an OCR scan.

It may prove advantageous that close range identification of the field device, which promotes eye contact with the field device, prevents an incorrect field device from being operated. As a further advantage, it can be considered that only authorized persons can operate the field device.

According to an embodiment, the identification feature of the field device can be received by means of the readout device over a distance between 0 m and 2 m, in particular between 0 m and 0.5 m, for example between 0 m and 20 cm.

This may help to identify the field device only over a short distance, i.e., in a close range. A first advantage of this embodiment is the creation of a visual contact, i.e. a clear association between the field device and the readout device. A second advantage of this embodiment is that because the field device can only be identified at close range, another device is not accidentally read out.

According to an embodiment, the field device is self-sufficient and is adapted to be woken up from a power saving mode by an identification by means of the readout device.

This may contribute to the need for the user to be present on site at the field device for measurement point registration. The advantage of this embodiment is that the safety aspects, such as registration of the correct field device, are also taken into account for authorized personnel.

According to an embodiment, the field device has a two-wire Ethernet interface.

One aspect relates to the use of a field device for registration in a cloud-based measuring point registration system.

Advantageously, the same or similar field devices can be set easily, quickly and cost-efficiently after registration. This is ensured by automatic suggestions of the cloud-based system.

One aspect relates to using a readout device to read and transmit an identification feature of a field device to a cloud-based field device control system.

One aspect relates to using a cloud-based field device control system to generate an identifier of a field device.

One aspect relates to a method for registering a field device in a cloud-based field device control system. The method comprises the steps of: Logging into a cloud-based field device control system using a readout device;

Reading the identification feature of the field device in response to a corresponding request from the cloud-based field device control system; Verification of the identification feature; and Adding and thus registering the field device in the cloud-based field device control system as a new field device.

The aim of this method is to identify and register the field device by means of its identification feature in a cloud-based field device control system, for example by means of a unique mapping between the identification feature of the field device and its digital twins and the account of the operator.

According to an embodiment, the transfer of measurement data from the field device to the cloud-based system is signaled/indicated by means of an illumination unit on the field device and/or by means of a signal or message on the readout device.

The illumination unit can be, for example, a flashing LED or graphic display.

According to an embodiment, the following steps are performed: Reading in the settings for measuring rate intervals and/or designations of the measuring point at the readout device by means of the operating program;

Transfer settings from the readout device to the field device.

According to an embodiment, the cloud-based field device control system is set up to suggest settings of similar field devices by means of the operating program.

Advantageously, this simple and automatic measuring point registration allows one or more field devices, including field devices that are operated autonomously by means of battery/battery, to be registered quickly, unambiguously and easily on a cloud-based system.

Advantageously, several field devices of the same type can be quickly adjusted, e.g. in the case of a tank farm with several silos and field devices mounted on them that measure in the same way.

Advantageously, the same or similar field devices can be set easily, quickly and cost-efficiently after registration. This is ensured by automatic suggestions of the cloud-based system.

One aspect relates to a program element that, when executed on a field device, a mobile readout device, a cloud-based field device control system, and/or on another computing device, instructs the field device, the mobile readout device, the cloud-based field device control system, and/or the computing device to perform the method steps described above and below. For example, the program element may be executed as an app on at least one of these devices.

One aspect relates to a computer-readable medium on which a program element described above is stored.

For further clarification, the disclosure is described with reference to embodiments illustrated in the figures. These embodiments are to be understood only as examples and not as limitations.

### BRIEF DESCRIPTION OF THE FIGURES

FIG. 1 schematically shows a cloud-based measuring point registration system of a field device.

FIG. 2 schematically shows a cloud-based measuring point registration system of a field device.

FIG. 3 shows a flow diagram of a process according to one embodiment.

### DETAILED DESCRIPTION OF EMBODIMENTS

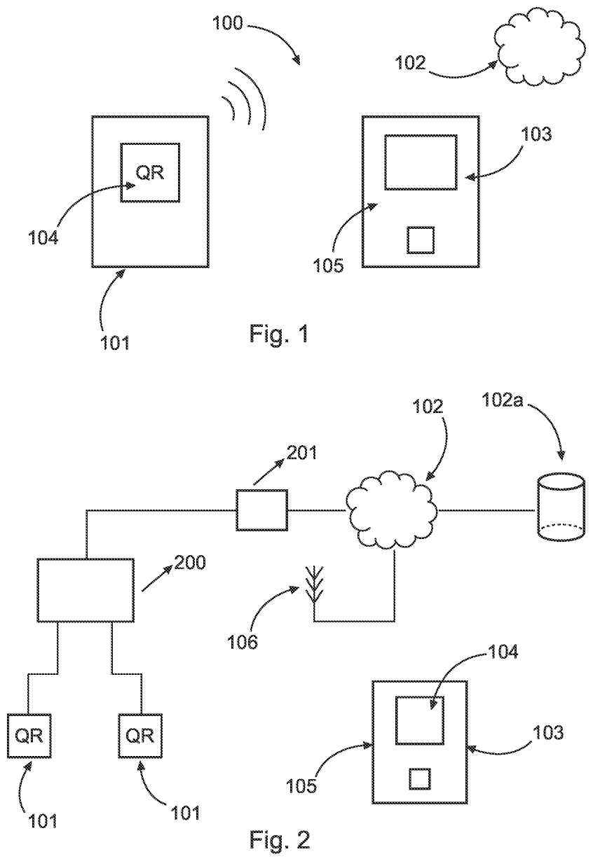

FIG. 1 schematically shows a cloud-based measuring point registration system 100 of a field device 101 according to one embodiment. The measuring point registration system 100 is arranged to register the field device 101 in a cloud-based field device control system 102. In this embodiment, the field device 101 is a field device 101 having a wireless interface. The field device 101 may be wirelessly connected to a readout device 103. In particular, the field device is a level, temperature, pressure, density, level limit, and/or flow meter. The cloud-based field device control system 102 is arranged to control the field device 101. The cloud-based field device control system 102 is configured as a visualization system for monitoring and controlling processes.

For example, it is a VEGA Inventory System, a web-based software for data acquisition and visualization of level data, e.g. in storage tanks and silos. The VEGA

Inventory System is installed on a company's local server and communicates with a cloud-based system 102 via a wireless network.

The readout device 103 is embodied as a smartphone, a tablet, a laptop, or a smartwatch. The readout device 103 logs into the cloud-based field device control system 102 (upon launching an operating program 105). In response to a request from the cloud-based field device control system 102, the readout device 103 reads the identification feature 104 of the field device 101. Further, the readout device 103 verifies the identification feature 104 of the field device 101. Verifying the identification feature 104 is a matter of checking whether such a field device 101 is already registered in a cloud-based field device control system 102. In the case where such a field device 101 is already known to a cloud-based field device control system 102, the optimal settings and parameters are suggested. According to this verification, the readout device 103 adds the field device 101 to the cloud-based field device control system 102 as a new field device 101. Other registration data, such as a documentation, parameter setting, history, firmware, inspection records, drawings, device state, etc. of the field device, are captured from the identification feature 104 at the operation program 105 and transmitted to a cloud-based field device control system 102 by means of a wireless network. Thus, registration of the field device 101 in the cloud-based field device control system 102 is completed. The operator program 105 automatically transmits and receives the registration data via radio network of the cloud-based system 102.

The identification feature 104 of the field device 101 is stored, for example, on the internal register of the field device 101, alternatively or additionally, the identification feature 104 is implemented as a badge on the device 101.

The identification feature 104 is secured by the coding. The identification feature is implemented as a barcode or a QR code (QR: “Quick Response” code) and/or in another representation. Alternatively, the identification feature 104 is embodied as a near-field communication module that emits the encoded or recoded signal using, for example, an RFID (radio frequency identification). The identification feature may be read via near-field communication, via a QR code, and/or via an OCR scan.

The QR code can, for example, be stored on the register of the field device or displayed on the nameplate in accordance with a standard—e.g. DIN SPEC 91406:2019-12 “Automatic identification of physical objects and information on the physical object in IT systems, in particular IoT systems; text in German and English”. The QR code may link the device to a so-called “digital twin”, e.g. by providing the QR code with a link to documentation, parameter setting, history, firmware, test protocols, drawings, device status, etc. of the field device. Furthermore, the QR code can be used to obtain authorization for device access (“login”).

FIG. 2 schematically illustrates a cloud-based measurement point registration system 100 of a field device 101 according to another embodiment. In this embodiment, the field device 101 is in particular a wired field device 101. The field device 101 has a two-wire Ethernet interface, which is converted to a multi-wire Ethernet interface by a fieldswitch 200. The field device 101 transmits the process and visualization data to a control system 201 by means of a multi-wire Ethernet interface.

By means of the readout device 103, the identification feature 104 of the field device is detected. The operating program 105 installed on the readout device 103 logs into a cloud-based system 102.

Accordingly, the measurement point registration of the field device 101 is performed in a cloud-based system 102. The registration data is transmitted via radio network of the cloud-based system 106. The cloud-based system 102 is stored on the server 102a.

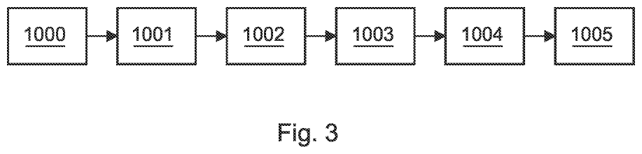

FIG. 3 shows a flowchart of a method for registering a field device 101 in a cloud-based field device control system 102 according to one embodiment of the present disclosure. In a step 1000, logging into a cloud-based field device control system 102 is performed using a readout device 103. In a step 1001, the identification feature 104 of the field device 101 is read out in response to a corresponding request from the cloud-based field device control system 102.

In a step 1002, the identification feature 104 is verified. In a step 1003, the field device 101 is added in the cloud-based field device control system 102. Thus, registering the field device 101 as a new field device in the system 102 is completed.

The aim of this method is to register the field device 101 by means of its identification feature 104 in a cloud-based field device control system 102, for example by providing a unique mapping between the identification feature 102 of the field device 101 and its digital twins.

The transfer of measurement data from the field device 101 to the cloud-based system 102 is signaled/indicated by means of an illumination unit on the field device 101 and/or by means of a signal or message on the readout device 103.

The illumination unit is, for example, a flashing LED or graphic display.

In a step 1004, the settings for measuring rate intervals and/or designations of the measuring point are read in at the readout device 104 by means of the operating program 105. In a step 1005, the settings are transferred from the readout device 103 to the field device 101.

According to one embodiment, the cloud-based field device control system 102 is arranged to suggest settings of similar field devices 101 by means of the operator program 105.

Advantageously, this simple and automatic measuring point registration allows one or more field devices, including field devices that are operated autonomously by means of battery/battery, to be registered quickly, unambiguously and easily on a cloud-based system.

1. A cloud-based measuring point registration system configured to register a field device in a cloud-based field device control system, the cloud-based measuring point registration system comprising:
a readout device configured to read out an identification feature of the field device,
wherein the readout device is configured to:
log into the cloud-based field device control system, and
verify the identification feature of the field device and thereupon add the field device to the cloud-based field device control system as a new field device to register the field device.

2. The cloud-based measuring point registration system according to claim 1, further comprising:
a cloud-based field device control system configured to control the field device.

3. The cloud-based measuring point registration system according to claim 1, further comprising:
a second field device arranged for registration in the cloud-based field device control system.

4. The cloud-based measuring point registration system according to claim 1,
wherein the cloud-based field device control system is a VEGA inventory system.

5. The cloud-based measuring point registration system according to claim 1,
wherein the field device is configured for level measurement, temperature measurement, pressure measurement, density measurement, level limit measurement, and/or flow measurement.

6. The cloud-based measuring point registration system according to claim 1,
wherein the identification feature is read via near field communication, via QR code and/or via OCR scan.

7. The cloud-based measuring point registration system according to claim 1,
wherein identification of the field device is receivable by way of the readout device over a distance between 0 m and 2 m.

8. The cloud-based measuring point registration system according to claim 1,
wherein the field device is implemented autonomously and is configured to be woken up from a power saving mode by an identification by way of the readout device.

9. The cloud-based measuring point registration system according to claim 1,
wherein the field device comprises a two-wire Ethernet interface.

10. The cloud-based measuring point registration system according to claim 1,
wherein the readout device is configured to
log into the cloud-based field device control system when starting an operating program, and
read the identification feature of the field device upon a corresponding request of the cloud-based field device control system.

11. A field device configured to register in the cloud-based measuring point registration system according to claim 1.

12. A readout device configured to read out and transmit an identification feature of the field device according to claim 11 to a cloud-based field device control system.

13. A cloud-based field device control system configured to generate an identifier of the field device according to claim 11.

14. A method for registering a field device in a cloud-based field device control system, comprising:
logging into a cloud-based field device control system using a readout device;
reading an identification feature of the field device in response to a corresponding request from the cloud-based field device control system;
verifying the identification feature; and
adding and registering the field device in the cloud-based field device control system as a new field device.

15. The method according to claim 14,
wherein transfer of measurement data from the field device to the cloud-based field device control system is signaled/indicated by way of an illumination circuit on the field device and/or by way of a signal or message on the readout device.

16. The method according to claim 14, further comprising:
reading in settings for measuring rate intervals and/or designations of the measuring point at the readout device by way of an operating program; and
transferring settings from the readout device to the field device.

17. The method according to claim 14,
wherein the cloud-based field device control system is configured to suggest settings of similar field devices by way of an operator program.

18. A non-transitory computer readable medium having stored thereon a program element which, when executed on a field device, a mobile readout device, a cloud-based field device control system, and/or on computing circuitry, instructs the field device, the mobile readout device, the cloud-based field device control system, and/or the computing circuitry to perform a method for registering a field device in a cloud-based field device control system, comprising:
logging into a cloud-based field device control system using a readout device;
reading an identification feature of the field device in response to a corresponding request from the cloud-based field device control system;
verifying the identification feature; and
adding and registering the field device in the cloud-based field device control system as a new field device.

19. The cloud-based measuring point registration system according to claim 1,
wherein identification of the field device is receivable by way of the readout device over a distance between 0 m and 0.5 m.

20. The cloud-based measuring point registration system according to claim 1,
wherein identification of the field device is receivable by way of the readout device over a distance between 0 m and 20 cm.
